(19) United States
(12) Patent Application Publication
(10) Pub. No.: US 2014/0181954 A1
(43) Pub. Date: Jun. 26, 2014

(54) SYSTEM FOR CONVEYING AN IDENTITY AND METHOD OF DOING THE SAME

(71) Applicants: CHARLES CAMERON ROBERTSON, MOUNTAIN VIEW, CA (US); PAUL MICHAEL GERHARDT, PALO ALTO, CA (US)

(72) Inventors: CHARLES CAMERON ROBERTSON, MOUNTAIN VIEW, CA (US); PAUL MICHAEL GERHARDT, PALO ALTO, CA (US)

(21) Appl. No.: 14/141,181

(22) Filed: Dec. 26, 2013

Related U.S. Application Data
(60) Provisional application No. 61/848,073, filed on Dec. 26, 2012.

(51) Int. Cl. G06F 21/31

(52) U.S. Cl. CPC G06F 21/31
USPC 726/17

(57) ABSTRACT

A system is configured to communicate an identity and perform a physical task. The system has an application controlled identity device is configured to receive and to store a user identity. An application controlled detection device is communicatively coupled to the application controlled identity device. An actuator is communicatively coupled to the application controlled detection device. The application controlled detection device comprises computer code programmed to compare the identity with the stored identity. The application controlled detection device further comprises computer code programmed to activate the actuator when the identity matches the stored identity.

### RELATED APPLICATION

This application claims priority to provisional patent application U.S. Ser. No. 61/848,073 filed on Dec. 26, 2012, the entire contents of which is herein incorporated by reference.

### BACKGROUND

The embodiments herein relate generally to devices that implements software applications to signal information about the identity of the owner when brought into proximity of a software controlled actuation device to carry out a physical task.

Prior to embodiments of the disclosed invention, a number of systems that carried out commands based on detecting proximity cards as a form of identity, showing identity cards with photos to a camera or person or detecting unique, but easily copied, information about a person or device in their presence. There were also a number of systems that execute transactions or verify the identity of a user through credit cards or government issued identification which were also easily replicated.

These devices and techniques relied on an insecure representation of identity through physical credentials that could easily be copied or spoofed. Some of these devices went as far as using link-layer security to detect the presence of devices as a form of credential, however, there were numerous documented instances of link-layer security being compromised. Embodiments of the disclosed invention solve this problem.

### SUMMARY

A system is configured to communicate an identity and perform a physical task. The system has an application controlled identity device is configured to receive and to store a user identity. An application controlled detection device is communicatively coupled to the application controlled identity device. An actuator is communicatively coupled to the application controlled detection device. The application controlled detection device comprises computer code programmed to compare the identity with the stored identity. The application controlled detection device further comprises computer code programmed to activate the actuator when the identity matches the stored identity.

In some embodiments, the application controlled detection device further comprises computer code programmed to compare the identity with the stored identity when the actuator completes a physical test.

### BRIEF DESCRIPTION OF THE FIGURES

The detailed description of some embodiments of the invention is made below with reference to the accompanying figures, wherein like numerals represent corresponding parts of the figures.

FIG. 1 shows a schematic view of one embodiment of the present invention.

FIG. 2 shows a schematic view of one embodiment of the present invention.

FIG. 3 shows a schematic view of one embodiment of the present invention.

FIG. 4 shows a schematic view of one embodiment of the present invention.

FIG. 5 shows a schematic view of one embodiment of the present invention.

FIG. 6 shows a schematic view of one embodiment of the present invention.

FIG. 7 shows a schematic view of one embodiment of the present invention.

FIG. 8 shows a schematic view of one embodiment of the present invention.

FIG. 9 shows a schematic view of one embodiment of the present invention.

FIG. 10 shows a schematic view of one embodiment of the present invention.

FIG. 11 shows a schematic view of one embodiment of the present invention.

FIG. 12 shows a schematic view of one embodiment of the present invention.

FIG. 13 shows a schematic view of one embodiment of the present invention.

FIG. 14 shows a schematic view of one embodiment of the present invention.

FIG. 15 shows a schematic view of one embodiment of the present invention.

FIG. 16 shows a schematic view of one embodiment of the present invention.

FIG. 17 shows a schematic view of one embodiment of the present invention.

FIG. 18 shows a schematic view of one embodiment of the present invention.

FIG. 19 shows a schematic view of one embodiment of the present invention.

FIG. 20 shows a schematic view of one embodiment of the present invention.

FIG. 21 shows a schematic view of one embodiment of the present invention.

FIG. 22 shows a schematic view of one embodiment of the present invention.

### DETAILED DESCRIPTION OF CERTAIN EMBODIMENTS

An embodiment of the present invention includes a system for imparting and detecting a user's identity to and from wireless application controlled devices in both an “online” context where one or more of the devices communications with a web service as well as an “offline” context where one or more of the devices only communicates with other devices. Devices in the system may shift between online and offline contexts depending on available connectivity to the web service while still allowing for the primary function of conveying a user's identity. The system may programmatically carry out certain data exchanges or physical actuations depending on the specified or implied needs of the user or other users in the system.

The devices in the system may assume one of two primary roles whereby certain application controlled devices, are provisioned to convey the identity of a user wirelessly (“identity devices”) while other application controlled devices are provisioned to detect the identity of a user wirelessly (“detection devices”). Devices with generic interfaces may not be permanently provisioned with a user's identity, but instead convey a user's identity only through a specific actions such as but not limited to the entry of a pin code or a specific set of motions. Alternatively, third party devices which are not specified in either of the two primary roles may receive data from or transmit data to the system given its application controlled nature. This may include data such as but not limited to notification of the detection of an identity device by a detection device being conveyed to a third party device as a text message or push notification.

A user's identity may be conveyed both through application layers leveraging data such as software keys, proprietary data, pin codes or other data categories not enumerated here as well as through generic interfaces and profiles established on a link layer such as pin codes, specific gestures, specific movements, specific motions, specific button presses and other link layer profile data types not enumerated. The user may register their identity through one of the application controlled devices as well as register other devices associated with their identity after the initial registration. This identity registration may be contingent on a communicating with a boarder web service which facilitates or mirrors the registration. In the process of, or independent from, the initial registration, a user may register themselves to be the main administrator or “owner” of wireless application controlled devices that act to detect identity. The owner of an application controlled device may be able to specify certain commands

If a user is successfully identified through one of the methods above and potentially from one or more devices, the identifying application controlled device may carry out a default, preprogrammed or inferred command that results in one or more outcomes that include but are not limited to physical actuations, data transmissions and electrical signals.

The system abstracts identity from both the purely physical or purely virtual domains. Traditional physical identifiers might include material keys, key cards, government issued identification, credit cards, payment cards, name tags, human physical characteristics and behaviors and other identifiers not enumerated here. These physical identifiers may be lost or destroyed, compromising the security of the user as well as their ability to transact in the physical world. Traditional virtual identifiers may include passwords, pin codes, tokens, public keys, private keys, bank account data, specific demographic data, location data, accounts and digitized human physical characteristics including photo files, fingerprint files, retinal scan files, genetic material files, behavioral tracking files, gait files as well as other data not enumerated here. As the user's identity is stored in the virtual domain and provisioned to a physical device, the system allows applications to more easily detect the user in a physical context and respond appropriately, whether in a preprogrammed or algorithmically inferred fashion, triggering either or both electrical or physical actuations. These electrical or physical actuations may be used for a variety of applications including but not limited to notifying third party software as to the arrival or departure of a user, securing or un-securing a physical perimeter, conforming to specified preferences of the user, executing payment as well as other applications not enumerated here.

Unlike purely physical identity tokens which may be lost or destroyed, identifying devices may be provisioned or decommissioned from the identity of their user either directly on a detecting device or through a web service which in turn instructs other detecting devices which may have cached the identity token for offline detection to remove its associated identity. Unlike purely virtual tokens, the system allows for detection of the user in a physical context as well as actuation in a physical context.

### EXAMPLE 1

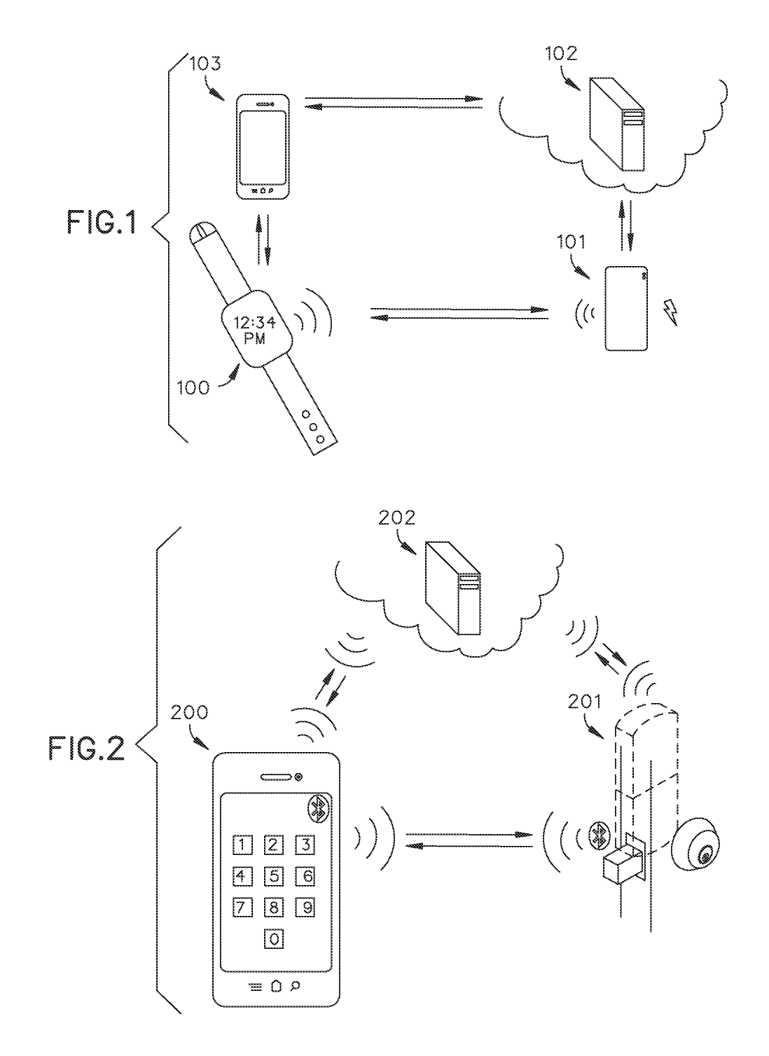

FIG. 1 shows wireless wristband device with a low-power radio 100 communicating with a wireless identity detecting electrical actuation device 101 after coming into proximity with it. The wireless communication may take place any number of wireless protocols that can include their own link layer security protocols. The electrical actuation device may send an electrical or data signal as a result of the communication. This signal may be relayed to the web-based application 102 that manages, provisions and processes the identity of the user of the wristband device. The wireless wristband device may communicate via its low-power radio to a device which has both low and high power radios 103 such as the non-limiting examples of a cellphone, tablet or laptop computer with WiFi, Ethernet, GSM, CDMA or other IP capable protocols. In turn, the device connects to the web-based application 102 relaying data to and from as well as provisioning the use of the wireless wristband device 100 as a personal identifier.

In this example, wireless wristband device with a low-power radio 100 is an identity device. When programmed with computer code from web-based application 102 it becomes an application controlled identity device. Similarly, device which has both low and high power radios 103 is a detection device. When programmed with computer code from web-based application 102 it becomes an application controlled detection device. Wireless electrical actuation device 101 further comprises an actuator.

### EXAMPLE 2

FIG. 2 depicts the initial provisioning process between keypad 200, a wireless application controlled identity device, access control detection device 201, an application controlled detection device. Web service 202 facilitates sharing both link layer and application layer secret tokens, if present, between the applications on the two devices to allow for a seamless pairing from the perspective of the user. The pairing takes place at both a link-layer as well as application layer. The identity device may in turn request the user to enter additional authentication factors such as a pin code depending on the authentication requirements of the detection device.

### EXAMPLE 3

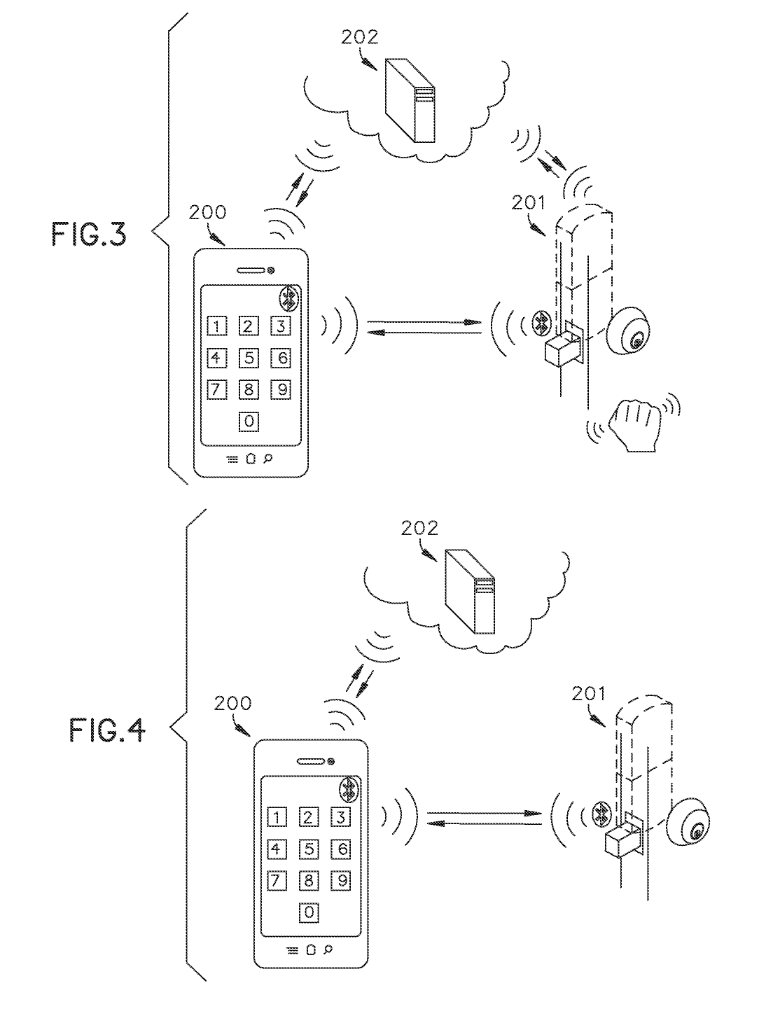

FIG. 3 demonstrates a slight reconfiguration of FIG. 2 whereby a physical test is used with one of the devices, in this case a knock to access control detection device, to initial the pairing mode necessary for provisioning. Given that access control detection device 201 is behind a secure perimeter, there are only a limited number of sensors that may trigger the device, in this non-limiting example a piezo microphone or accelerometer that detect movement in the device, completing a physical test.

In this case the connection between either keypad 200 or access control detection device 201 and identity web service 202 may be intermittent, caching necessary application layer pairing information on either of the devices. This information may include link layer pairing tokens as well as application layer pairing tokens that verify the devices in order to preclude so-called man-in-the-middle or brute force attacks from other malicious devices eavesdropping on the wireless exchange.

### EXAMPLE 4

FIG. 4 demonstrates a slight reconfiguration of FIG. 2 whereby keypad 200 receives application layer pairing information from identity web service 202. While link layer pairing to the access control device 201 may be open to any device, in this non-limited example Bluetooth, only an application layer shared secret which is generated by the web service will enable the application controlled device to send and receive authorized commands. The web service is able to generate the appropriate shared secret the access control device has been previously registered with the web service.

### EXAMPLE 5

FIG. 5 depicts a range of potential devices that may be application controlled or used as a direct interface to convey identity to application controlled detection devices through link-layer protocols, in this non-limiting example Bluetooth, and proximity detection. These include devices with integrated wireless communications such as cellphone or tablet device 500, sporting activities detector 501, music player 502, key with wireless component 503, object-finder device or wireless access credential 504, health and activity monitor 505 or watch or wristband device 506. In the cast of being used as a direct interface, these devices may transmit data that conforms to link layer protocols and profiles related to the category of device. Non-limiting examples include motion data from sporting activities detectors, button press data from key fobs, music data from key fobs, movement and human health factor data from fitness trackers and pin code data from numerical key pads.

### EXAMPLE 6

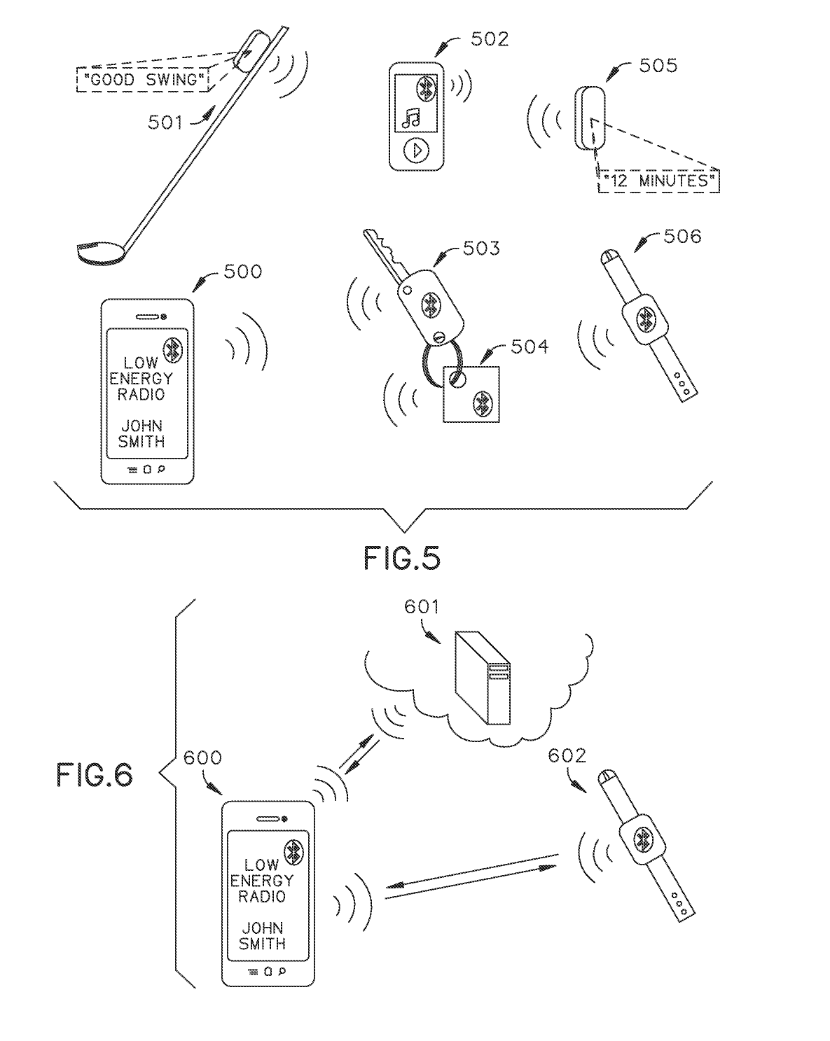

FIG. 6 depicts smartphone 600, a wireless application controlled device, communicating with identity web service 601 in order to provision smart watch 602, an additional wireless application controlled device, with application layer identity information and pairing information that may be necessary to pair with application controlled identity detection devices. This is similar or the same type of information noted in FIG. 2, including both link layer and application layer pairing data. Once provisioned, the smart watch conveys the users identity in the same fashion that smartphone 600 would to a detection device. In this non-limiting example, smart watch 602 and smartphone 600 communicate over the Bluetooth protocol, however, this could be any wireless standard. Conversely, the smartphone leverages its relatively higher powered wireless radio connection to web service over standard web communication protocols including but not limited to TCP/IP, UDP, HTTP, FTP, SSH and SSL.

### EXAMPLE 7

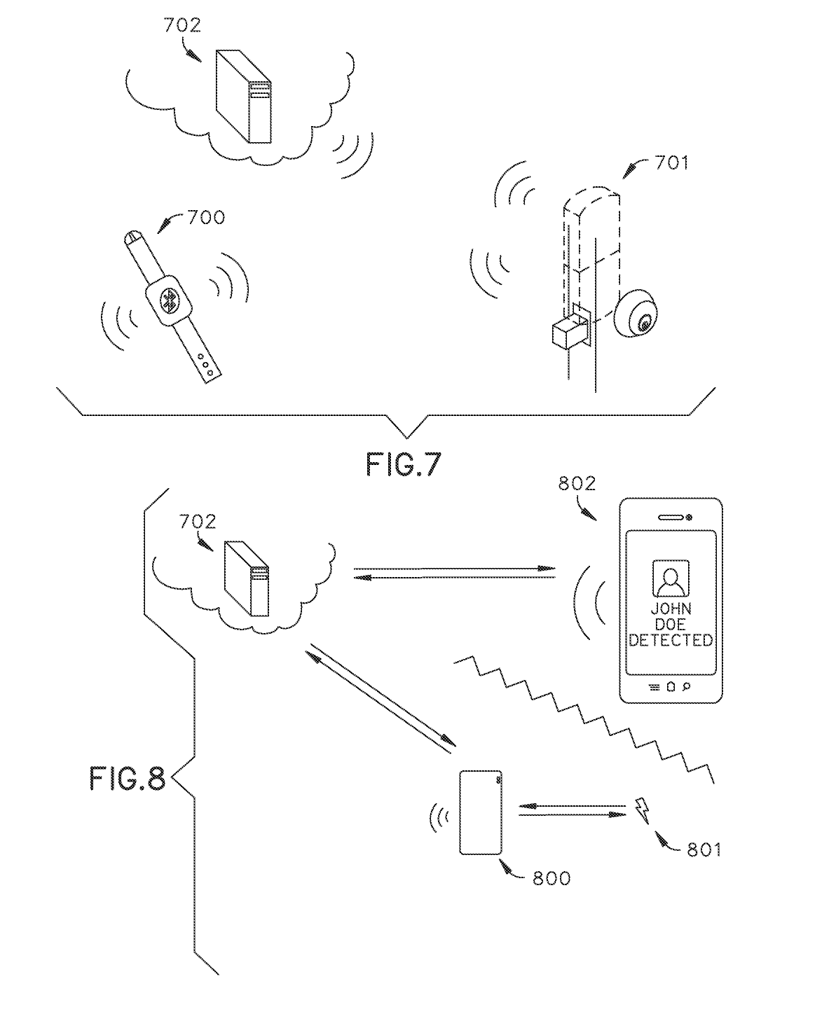

FIG. 7 depicts a wireless wristwatch 700, a provisioned wireless application controlled identity device, conveying identity to locking device 701, a wireless application controlled detection device, which in turn executes a command. Locking device 701, conversely, may relay data to web service 702; this data can include verifying that wristwatch 700 is authenticated to carry out commands. In this non-limiting example, wireless wristwatch 700 is “offline” and cannot communicate directly with web service 702. As such it is leveraging its secure, cached identity information to potentially pair with and communicate with locking device 701. In the event this device is lost, damaged or its security compromised, web service 702 could be notified to revoke access to the device by the user and locking system 702 would no longer recognize wireless wristwatch 700 as representing the identity of the user. Wireless wristwatch 700 may also communicate indirectly with web service 702 through locking device 701 over an encrypted communication protocol unreadable to locking device 701 so as to update data, including but not limited to secure key or token data that may periodically become invalid.

### EXAMPLE 8

FIG. 8 depicts an slight reconfiguration of FIG. 7 whereby wireless wristwatch 700 communicates with generic software application controlled detection device 800 that may either actuate another device 801 through an electrical signal or current as well as potentially relay this information to web service 702. In turn, web service 702 may relay information to another provisioned device such as smartphone 802, an application controlled device, as to the presence of the detected watch's owner. Depending on the privacy settings of the user on web service 702, the identity of the user may or may not be permitted to be further relayed to other applications and devices such as smartphone 802. The recipient device of notification may in turn be authenticated as the identity device of another user who has control over generic software application controlled detection device 800. The user may leverage the an application on the smartphone to instruct the detection device to grant certain control privileges to wireless wristwatch 700 on a permanent or temporary basis so that it may execute actuation commands to another device 801.

### EXAMPLE 9

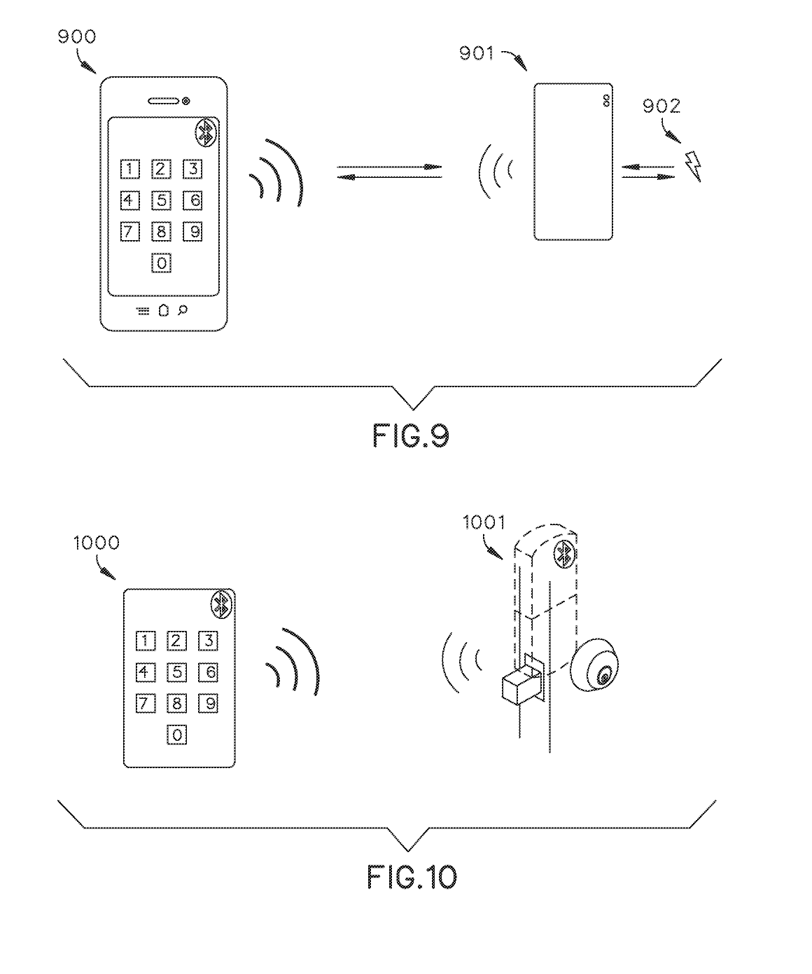

FIG. 9 depicts smartphone 900, a wireless application controlled device, communicating with another wireless application controlled device 901 through a standard interface so as to carry out certain approved commands with other devices 902. The devices may or may not have not undergo any secure pairing procedures before transmission of the code. In this non-limiting example, the standard interface is a Bluetooth profile defining keypad or keyboard devices.

### EXAMPLE 10

FIG. 10 depicts a slight reconfiguration of FIG. 9 whereby fixed numerical keypad 1000, a wireless application controlled device, signals over a standard interface to application controlled locking system 1001 that in this case is behind a secured perimeter but is within wireless range. Numerical keypad 1000 may leverage application and link layer security to encrypt communications, however, it may still be allowed to convey valid commands despite being a previously unknown and unpaired device.

### EXAMPLE 11

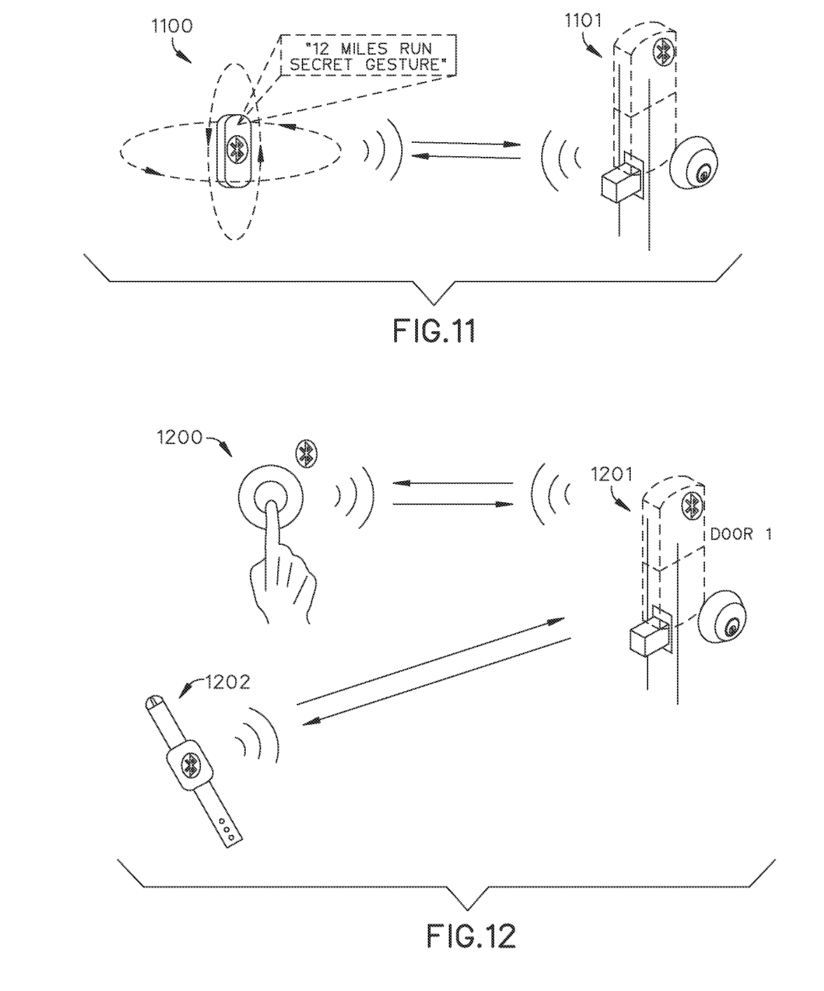

FIG. 11 is an alternate configuration of FIG. 9 whereby wireless enabled fitness tracker 1100, a wireless application controlled device 1100, signals over a standard interface to an application controlled locking system 1101 that, in this case, is behind a secured perimeter but is within wireless range. The wireless enabled fitness tracker 1100 may leverage its accelerometer to convey the data associated with a physical test comprising specific motions that, in turn, are recognized as a unique key that, if accepted, by application controlled locking system 1101, triggers an actuator which performs a physical task such as locking or unlocking Similar to FIG. 9, this is a non-limiting example, whereby the standard interface is a Bluetooth profile defining fitness tracking or health monitoring devices and the locking system has sufficient logic to interact with and discern the specific motion data for the physical test from these profiles.

### EXAMPLE 12

FIG. 12 depicts a system whereby wireless doorbell button 1200, a wireless application device, both acts as a trigger for commands to locking system 1201, a second wireless application device, as well as a detector of smart watch 1202, another wireless application controlled device. In this specific example, the locking system 1201 detects the presence of smart watch 1202 and receives the trigger signal of wireless doorbell button 1200 before carrying out the physical test such as locking or unlocking

### EXAMPLE 13

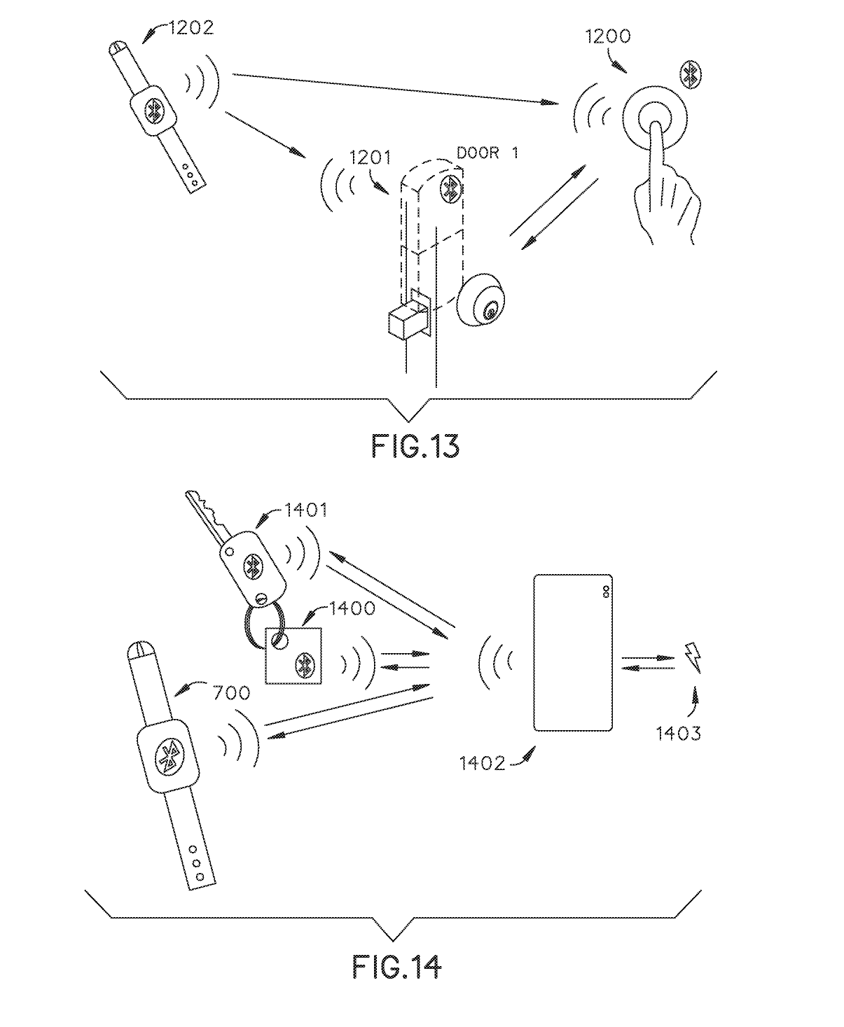

FIG. 13 is a slight reconfiguration of FIG. 12 whereby wireless doorbell button 1200, a wireless application controlled device 1200 is placed on the outside of a secure perimeter from locking system 1201, another wireless application controlled device. By software communication and triangulation using relative signal strength, wireless doorbell button 1200 and locking system 1201 may establish whether third wireless application controlled identity device 1202 is inside or outside of the secure perimeter.

### EXAMPLE 14

FIG. 14 is an alternate configuration of FIG. 8 whereby multiple wireless application controlled identity devices 700, 1400, 1401 convey identity to wireless application controlled device 1402 that may either actuate another device 1403 through an electrical signal to perform a physical act or current or relay this information to another service or device. In this case, the wireless application controlled device 1402 may require that all of the identity devices 700, 1400, 1401 be whitelisted in order to carry out a command as a form of multiple factor authentication. In the case where only one device 700 is whitelisted, the wireless application controlled device 1402 may carry out a successful command 1403 that is different than commands where more identity factors are present.

### EXAMPLE 15

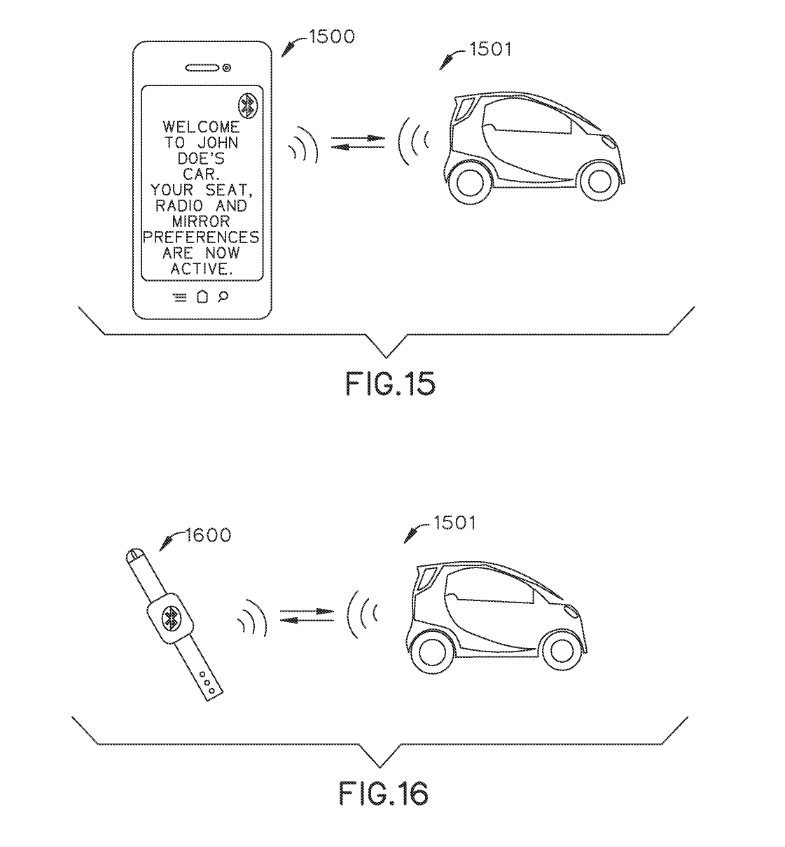

FIG. 15 depicts smartphone 1500, a wireless application controlled identity device, in bi-directional communication with car 1501, a wireless application controlled detection device. If properly provisioned, smartphone 1500 may convey certain preferences to car 1501 depending on the preferences established in the application by the identity of the owner. These preferences may be explicitly set by the owner of smartphone 1500 or inferred by the owner's behavior with car 1501 or other wireless application controlled devices. The provisioning process may take place in either an online or offline environment and may or may not involve a web service, either the communicating with smartphone 1500 independently, car 1501 independently or both.

### EXAMPLE 16

FIG. 16 is a slight reconfiguration of FIG. 15 whereby watch 1600, a wireless application controlled identity device 1600 engages with bi-direction communication with car 1601, a wireless application controlled detection device. The watch may be an offline device that has first been provisioned with a user's identity through another application controlled wireless device.

### EXAMPLE 17

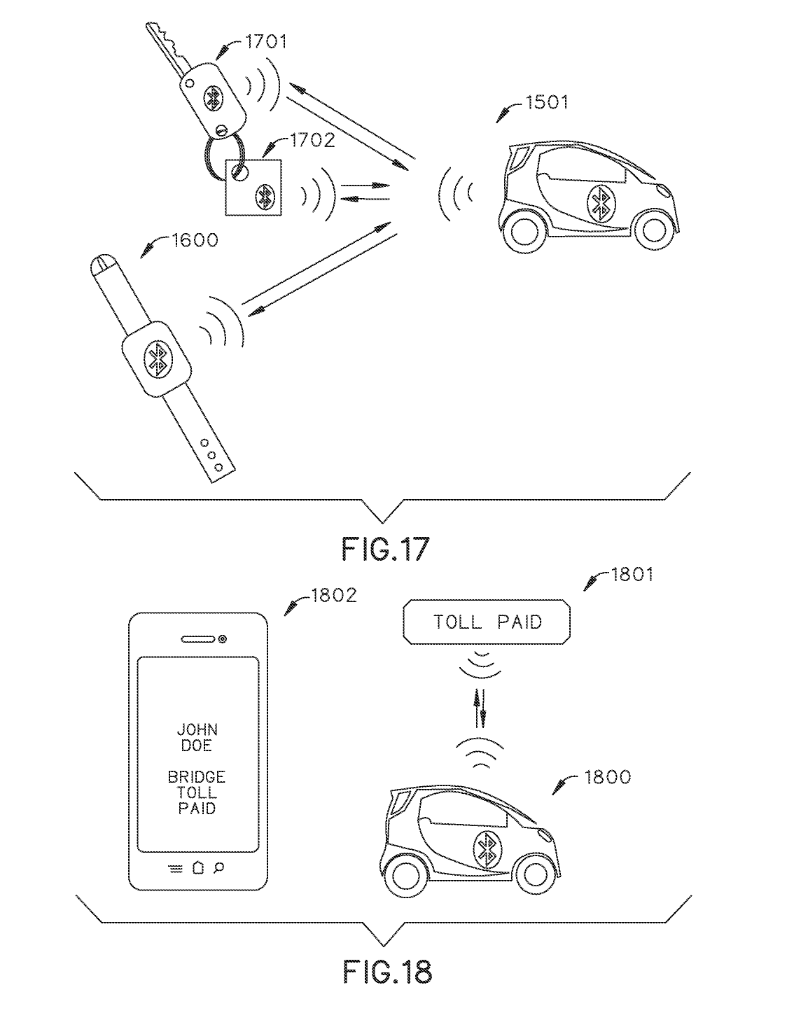

FIG. 17 is a slight reconfiguration of FIGS. 14 and 15 whereby multiple application controlled identity devices 1600, 1700, 1701 convey identity to car 1501, a wireless application controlled detection device. Depending on the provisioning of wireless application controlled detection device 1501 and multiple application controlled identity devices 1600, 1700, 1701, the car may carry out a range of non-limiting commands ranging from security actions such as unlocking and locking to mobility actions such as starting to preferential actions such as seat adjustment. Car 1501 may also independently relay information about multiple application controlled identity devices 1600, 1700, 1701, or from the identity devices to a web service.

### EXAMPLE 18

FIG. 18 depicts car 1800, a wireless application controlled identity device, that has been provisioned with the user's identity. In this non-limiting example car 1800 is passing through toll booth 1801, a wireless application controlled detection device, and successfully paying the toll based on the conveyance of identity from car 1800 to toll booth 1801. In turn, a notification may be conveyed to another wireless application controlled identity device 1802 about the completion of the toll. This information may be conveyed directly from car 1800 or indirectly through a web service that is in communication with toll booth 1801.

### EXAMPLE 19

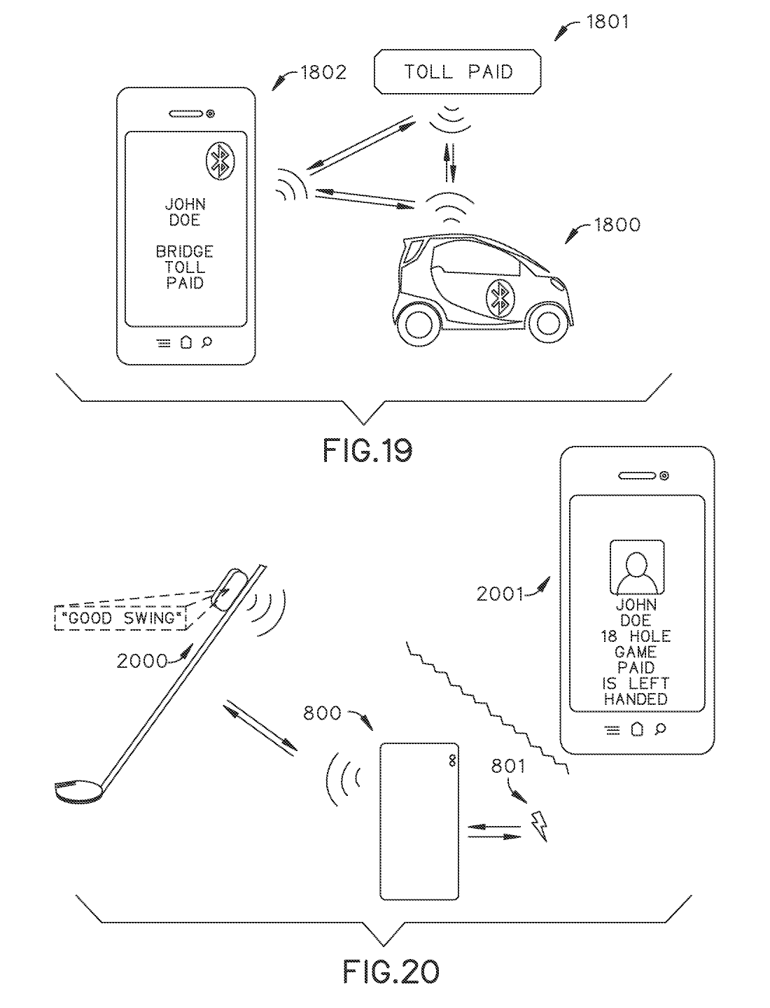

FIG. 19 depicts a slight reconfiguration of FIG. 18 whereby smartphone 1802, a wireless application controlled identity device, conveys the user's identity to car 1900, a wireless application controlled detection device. Smartphone 1802 may interact with car 1900 and toll booth 1801 to either authorize payment or preclude the authorization of payment if the appropriate identity is not detected from the smartphone.

Car 1900 may act both in the roles of a detection device or an identity device depending what other devices it is communicating with. In this case, car 1900 and smartphone 1802 leverage the non-limiting example of the Bluetooth protocol to communicate.

### EXAMPLE 20

FIG. 20 depicts a slight reconfiguration of FIG. 8 whereby, sporting activity detector 2000, a wireless application controlled identity device communicates with generic software application controlled device 800 that may actuate actuator 801 through an electrical signal or current as well as optionally relay this information to web service 803.

In turn, web service 803 may relay information to another provisioned device such as application-controlled smartphone 2001 as to the presence of an identity provisioned sporting activity detector 2000 and the preferences of the user related to the specific activity they are carrying out. Additional information collected by the sporting activity detector may be relayed to generic software application controlled device 800 so as to be associated with the identified user, and in turn uploaded to a database on web service 803.

### EXAMPLE 21

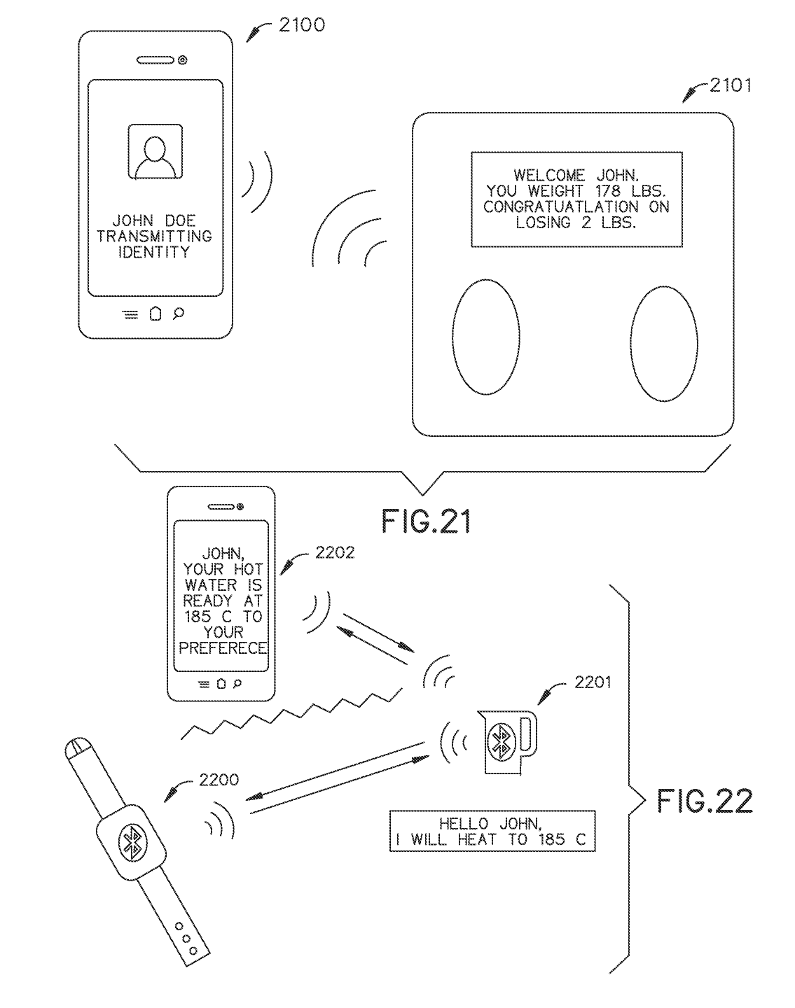

FIG. 21 depicts a smartphone 2100, a wireless application controlled identity device, conveying the identity of its user to bathroom scale 2102, a wireless application controlled detection device. In turn, bathroom scale 2101 may convey personalized information to the person on the scale as well as relay data back to smartphone 2100. In this non-limiting example, bathroom scale 2102 and smartphone 2100 communicate over the Bluetooth protocol. Smartphone 2100 may also cache and relay information stored on bathroom scale 2102 for further processing, storage and use, either locally on the smartphone or on a remote web service.

### EXAMPLE 22

FIG. 22 depicts a slight reconfiguration of FIG. 21 whereby smart watch 2200, a wireless application controlled identity device, conveys the identity of its user to tea kettle 2201, a wireless application controlled detection device. In turn tea kettle 2201 may adapt its settings to conform to explicit or inferred preferences of the user. Furthermore, tea kettle 2201 may communicate directly or indirectly with another application provisioned device 2202, such as a smartphone, in order to perform a physical task such as convey delayed data about the state of a requested task, in this example a notification that water in the kettle has reached a certain, preferred temperature.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system configured to communicate an identity and perform a physical task; the system comprising:
an application controlled identity device configured to receive and to store a user identity;
an application controlled detection device communicatively coupled to the application controlled identity device; and
an actuator communicatively coupled to the application controlled detection device;
wherein the application controlled detection device comprises computer code programmed to compare the identity with the stored identity;
wherein the application controlled detection device further comprises computer code programmed to activate the actuator when the identity matches the stored identity.

2. The system of claim 1, wherein the application controlled detection device further comprises computer code programmed to compare the identity with the stored identity when the actuator completes a physical test.

3. A system configured to communicate an identity during a physical task; the system comprising:
an application controlled identity device configured to receive and to store a user identity;
an application controlled detection device communicatively coupled to the application controlled identity device; and
an actuator communicatively coupled to the application controlled detection device;
wherein the application controlled detection device comprises computer code programmed to compare the identity with the stored identity;
wherein the application controlled detection device further comprises computer code programmed to compare the identity with the stored identity when the actuator completes a physical test.

4. A process for completing a physical task for a verified user; the process comprising:
storing an identity in an application controlled identity device;
connecting the application controlled identity device to a application controlled detection device;
connecting an actuator to the application controlled detection device;
storing a stored identity in the application controlled detection device;
communicating the identity from the application controlled identity device to a application controlled detection device;
comparing the identity with the stored identity; and
engaging the actuator to complete the physical task when the stored identity matches the identity.
